(19) United States
(12) Patent Application Publication
(10) Pub. No.: US 2025/0025795 A1
(43) Pub. Date: Jan. 23, 2025

(54) GAMING DEVICE WITH FLEXIBLE INPUT LEVER ATTACHMENT

(71) Applicant: Nathan ROSENE, Plano, TX (US)

(72) Inventor: Nathan ROSENE, Plano, TX (US)

(21) Appl. No.: 18/772,754

(22) Filed: Jul. 15, 2024

Related U.S. Application Data
(60) Provisional application No. 63/514,670, filed on Jul. 20, 2023.

(51) Int. Cl. A63F 13/98

(52) U.S. Cl. CPC A63F 13/98

(57) ABSTRACT

A gaming device assembly can include an attachment configured to attach to a gaming device having one or more touch responsive surfaces, and at least one flexible device securable to the attachment. The flexible device includes one or more depressors configured to be positioned adjacent the touch responsive surfaces when the attachment is attached to the gaming device. A method of using a gaming device can include attaching an attachment to the gaming device, and attaching a flexible device to the attachment, so that depressors of the flexible device are positioned operatively proximate respective touch responsive surfaces of the gaming device.

### CROSS-REFERENCE TO RELATED APPLICATION

This application claims the benefit of the filing date of U.S. provisional application No. 63/514,670 filed on 20 Jul. 2023. The entire disclosure of the prior application is incorporated herein by this reference for all purposes.

### BACKGROUND

This disclosure relates generally to gaming devices and, in an example described below, more particularly provides a gaming device with a flexible input lever attachment.

Many modern handheld video gaming devices allow for user input through the use of multiple actuation devices, typically including an electro-mechanical switch connected to an internal circuit. The primary actuation devices for user input are typically located on the front face of a handheld gaming device, and are typically intended for actuation by force applied by the thumbs.

Due to the needs of many games and applications requiring multiple and sometimes simultaneous inputs, many handheld gaming devices place additional buttons on the top surfaces of their housing, often referred to as shoulder buttons. These shoulder buttons or switches can typically be actuated through the use of the first, second, third or fourth finger. Modern handheld video gaming devices including multiple physical actuators are increasingly being packaged into smaller outer housings and enclosures.

It will, therefore, be readily appreciated that improvements are continually needed in the art of designing, constructing and utilizing handheld gaming devices. The present disclosure provides such improvements to the art, which improvements may be used with a wide variety of different gaming devices.

### BRIEF DESCRIPTION OF THE DRAWINGS

FIG. 1 is a representative rear perspective view of an example of a gaming device assembly that can incorporate the principles of this disclosure.

FIG. 2 is a representative rear elevational view of the FIG. 1 gaming device assembly.

FIG. 3 is a representative rear elevational view of the FIG. 1 gaming device assembly.

FIG. 4 is a representative side perspective view of the FIG. 1 gaming device assembly.

FIG. 5 is a representative front elevational view of another gaming device assembly that can incorporate the principles of this disclosure.

FIG. 6 is a representative top perspective view of the FIG. 5 gaming device assembly.

FIG. 7 is a representative front perspective view of the FIG. 5 gaming device assembly.

FIG. 8 is a representative top perspective view of the FIG. 5 gaming device assembly.

FIG. 9 is a representative rear perspective view of the FIG. 5 gaming device assembly.

FIG. 10 is a representative rear perspective view of the FIG. 5 gaming device assembly.

FIG. 11 is a representative rear view of another gaming device assembly that can incorporate the principles of this disclosure.

FIG. 12 is a representative rear perspective view of the FIG. 11 gaming device assembly.

FIG. 13 is a representative side perspective view of the FIG. 11 gaming device assembly.

FIG. 14 is a representative front perspective view of another gaming device assembly that can incorporate the principles of this disclosure.

FIG. 15 is a representative rear perspective view of the FIG. 14 gaming device assembly.

### DETAILED DESCRIPTION

Representatively illustrated in the accompanying drawings is a gaming device assembly 10 and associated method which can embody principles of this disclosure. However, it should be clearly understood that the gaming device assembly 10 and method are merely one example of an application of the principles of this disclosure in practice, and a wide variety of other examples are possible. Therefore, the scope of this disclosure is not limited at all to the details of the gaming device assembly 10 and method described herein and/or depicted in the drawings.

Placement of input switches, shoulder buttons or other touch-responsive surface on a gaming device can often be in locations that are hard to reach while comfortably grasping a housing of the gaming device. In examples described herein, the gaming device assembly 10 enables the gaming device to be comfortably grasped and the switches, buttons or other touch-responsive surfaces to be readily actuated during game play on the gaming device.

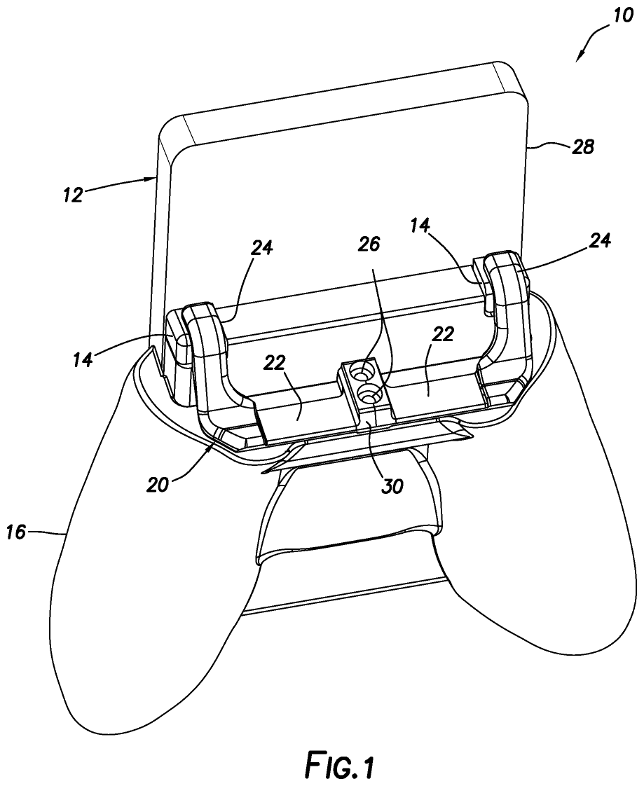

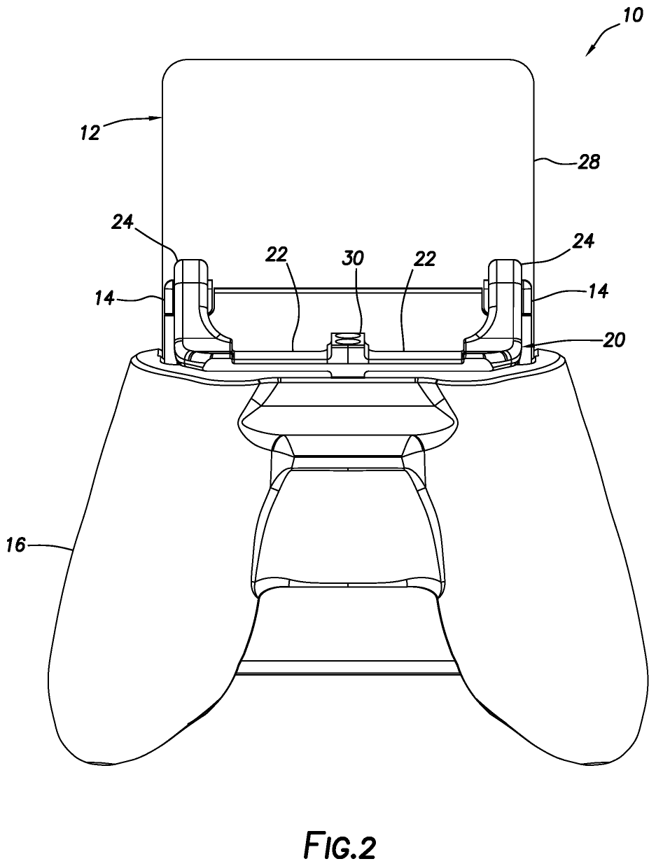

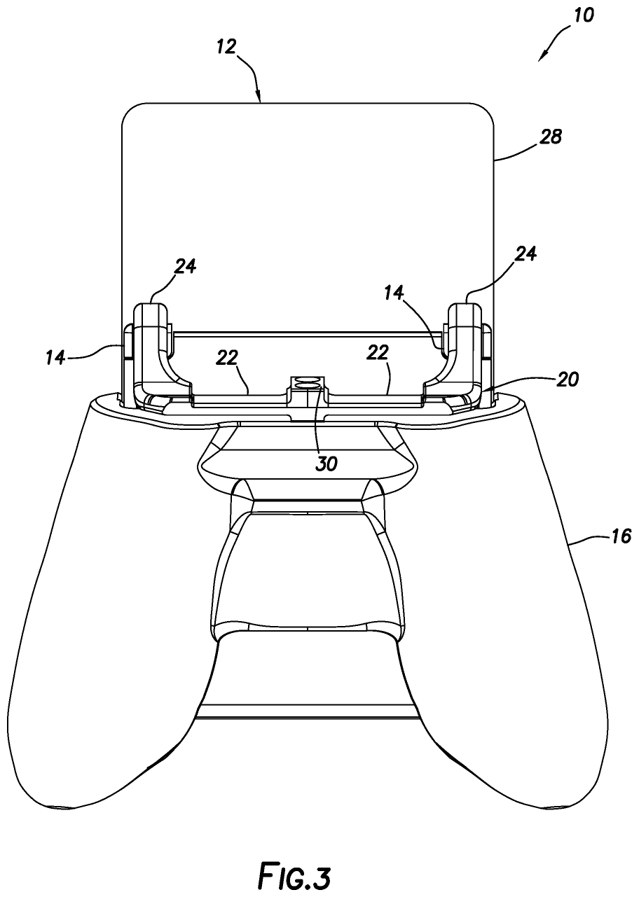

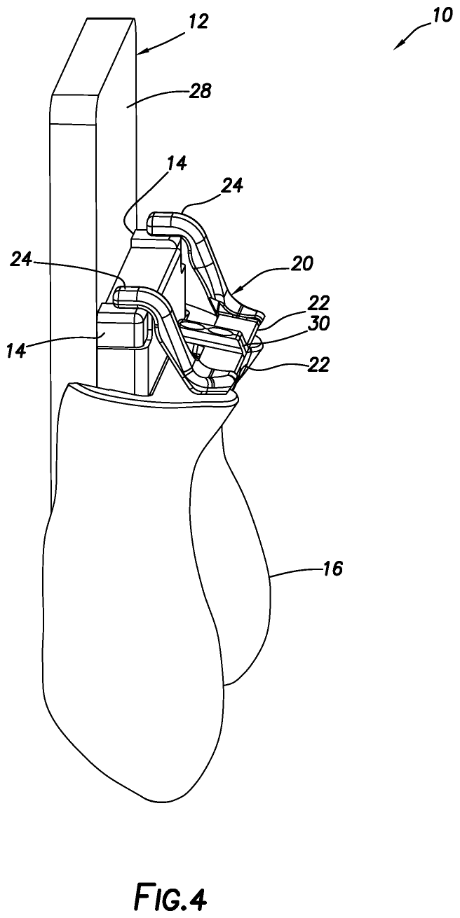

FIGS. 1-4 representatively illustrate a first example of the gaming device assembly 10. In this example, a gaming device 12 includes two shoulder buttons 14 that are located a relatively large vertical distance above a user's thumbs when the user grasps an attachment 16 configured to attach to the gaming device 12.

The shoulder buttons 14 are examples of touch-responsive surfaces that can be used to produce inputs to the gaming device 12. Actuation or activation of the touch responsive surfaces (for example, by depressing one or more of the buttons 14) will produce a responsive internal electronic functioning of the gaming device 12 (such as, to produce a change in game play by the user). Other types of touch responsive surfaces that can be used to produce a responsive internal electronic functioning of a gaming device can include a touch screen (capacitive, resistive, infrared, etc.), an optical sensor, a trackpad or other pressure sensitive device. The scope of this disclosure is not limited to use of any particular type of touch responsive surface with a gaming device.

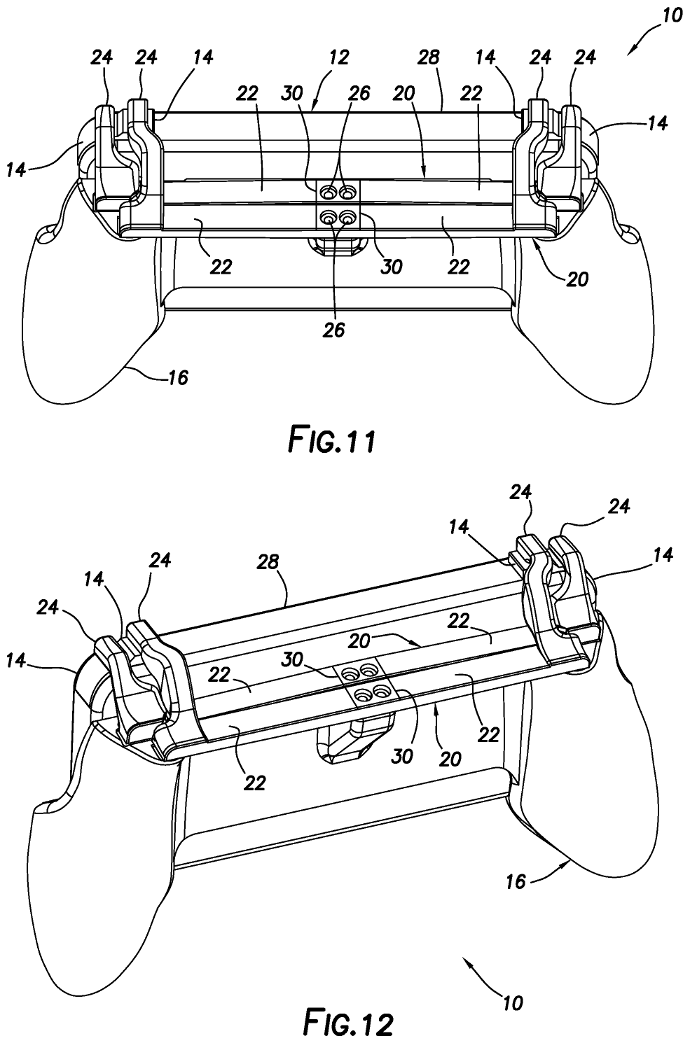

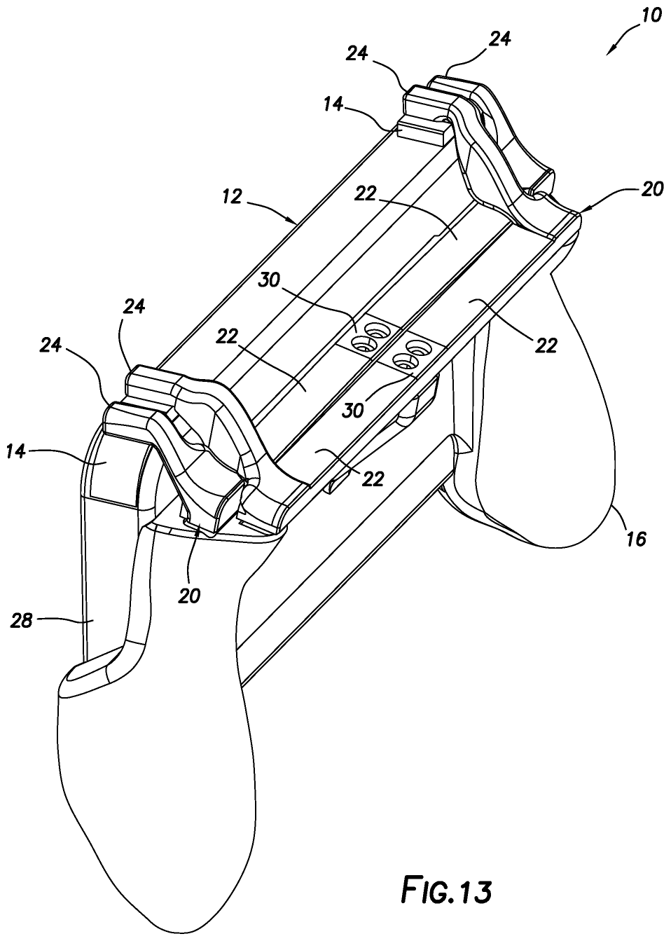

FIGS. 11-13 representatively illustrate another example of the assembly 10. In this example, the gaming device 12 includes four buttons 14 (or other type of touch responsive surface), two on each opposing side.

In the FIGS. 1-4 example, a method is provided to actuate the shoulder buttons 14 (or other type of touch responsive surface) with the index finger at a location that is closer in distance to the palm of the user's hand so that the index finger does not need to stretch upward or vertically in an uncomfortable manner.

In the FIGS. 11-13 example, the gaming device 12 is provided with multiple top-mounted shoulder buttons 14 that are arranged in an ergonomic array such that the primary two buttons on either side of the device 12 can be depressed with the two index fingers, and the two secondary buttons can be depressed with the two middle fingers at a distance further away from the user at a location further behind a screen 18 of the device.

The advantages of the assembly 10 can include the “relocation” of one or more buttons 14 (or other type of touch responsive surface). This can be achieved in one example by utilizing a single flexible device 20, thus reducing cost and complexity.

The assembly 10 can function in some examples to allow the end user to input forces into a handheld gaming device 12 comfortably. The user does not need to stretch their fingers into an uncomfortable position. Instead, the flexible device 20 allows the user to readily depress buttons 14 (or other type of touch responsive surface) with a smaller movement and shorter reach of the fingers.

In various examples, a purely mechanical means is provided for translating finger input forces into laterally opposed gaming device shoulder buttons 14 (or other type of touch responsive surface), allowing the input forces to be offset from the buttons. The input forces for the buttons 14 are translated through a flexible upper lateral member 22 with offset button depressors 24.

The lateral member 22 has significantly different stiffnesses in the three degrees of freedom. It is significantly stiffer in the translational degree of freedom towards and away from the user, and in the lateral direction from side to side.

The stiffness of the lateral member 22 is designed to be greatly reduced in the vertical direction to allow for flexibility in a direction of travel within an operative range (e.g., 15 degrees) of the button 14 travel direction.

The lateral members 22 can be connected to the attachment 16 with fasteners 26 (or another attachment means, whether releasable, temporary or permanent). The attachment 16 may be attached to the gaming device 12, for example, via a press fit, interference fit, outside clamping mechanism, or a self-contained clamping mechanism (for example, built into the attachment 16 and the flexible device 20).

The attachment 16 may contact the gaming device 12 via an intermediate lining or layer such as foam, rubber, polyurethane, cloth, felt, or other scratch resistant material.

The button depressors 24 are offset such that the fingertips of the user can rest comfortably behind the device 12. In some examples, the user's fingertips may be offset behind the actual button 14 on the device 12.

The button depressors 24 can also be offset such that the fingertips of the user can rest below the device button 14 input surface at a location closer to the palms of the user's hand than that which is allowed by the device 12.

The installation process preferably does not require any modification to the gaming device 12 itself. The attachment 16 and flexible device 20 may be removed or installed without disassembling an outer housing 28 of the gaming device 12.

Each flexible device 20 in the depicted examples comprises two flexible lateral members 22 extending outward from a fixed central portion 30 or clamp and laterally toward two respective buttons 14 or actuators on the gaming device 12.

There may be multiple flexible devices 20 that are secured to the same attachment 16 in some examples. Each flexible device 20 can be used to actuate two separate buttons 14 for multiples of 2, 4, 6, or 8 buttons to be pressed by the first, second, third and fourth fingers, respectively.

The fixed central portion 30 does not necessarily have to be centered on the device 20. Instead, it may be offset laterally to one side or the other.

All actuation is preferably performed by purely mechanical means. No electronics are involved in the depicted examples, although electronics may be provided if desired.

Each button depressor 24 travels in an arc when depressed, due to the shape of the flexible lateral member 22. The button depressor 24 contacts the shoulder button 14 at a tangent point or line, sliding slightly in the lateral direction as the button is pressed.

The button depressor 24 also may have a small component of forward travel to compensate for rearward flexure of the button actuation protrusion. This can be achieved by tilting the flexible lateral member 22 up and to the rear away from the user.

The flexible lateral member 22 in the depicted examples functions similarly to a transverse leaf spring found in some automobile suspension applications. The lateral members 22 on the left and the right side of the central portion 30 act and travel independently due to the two fasteners 26 clamping the central portion to the attachment 16.

The flexible device 20 may be attached to the attachment 16 by mechanical fasteners 26 (nut and bolt), magnetically, press-fit, sliding track, spring latch with button release, clasp and latch, adhesive, or other mechanical means.

The flexible device 20 in the depicted embodiments is fastened by an upper cap screw with a lower nut pressed into the attachment 16. An alternate embodiment allows for locking nuts to be inserted into the attachment 16 by means of an internal track. A further embodiment allows for one or more metallic threaded inserts to be included in the attachment 16.

The flexible device 20 may be concealed by a decorative cover or shroud for cosmetic purposes.

The flexible device 20 may be integrally formed with the attachment 16. This could be achieved by molding the two components as one body, or by using any of the other mentioned manufacturing processes to form both as one body. The entire attachment 16 and flexible device 20 could removably attach and detach from the gaming device 12 as one unit.

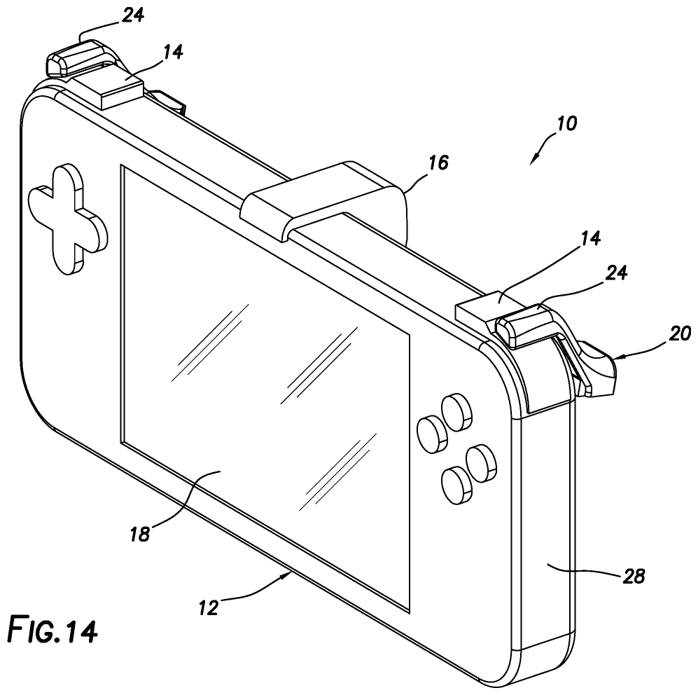

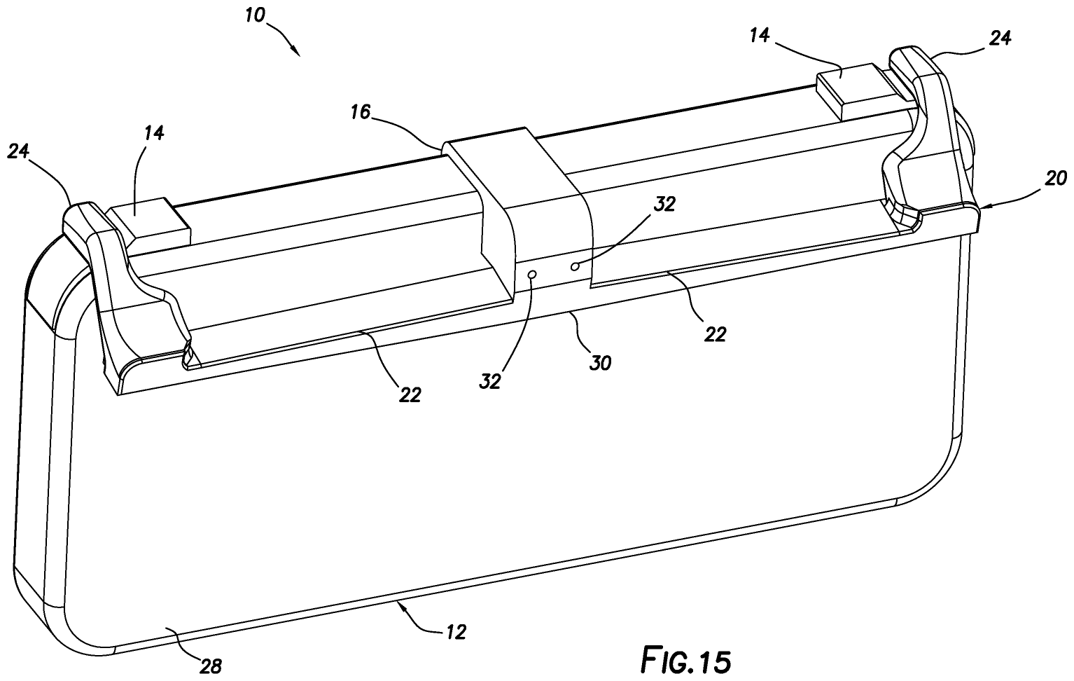

An alternate embodiment allows for the attachment 16 and the flexible device 20 to be clamped directly to the top of the gaming device 12 (see the example of FIGS. 14 & 15). In this example, holes 32 in a rear of the attachment 16 (which may be integrally formed with the flexible device 20) are internally threaded and set screws are used to clamp the attachment onto the gaming device 12.

The flexible device 20 in some examples may be manufactured out of ABS plastic by means of fused deposition modeling (FDM) printing (or other type of three dimensional printing), or injection molding.

The flexible device 20 in some examples may comprise a composite material molded over a metallic main body.

The flexible device 20 in some examples may comprise metal, wood, or other composite material, as long as the deflection of the flexible lateral members 22 in operation is within the elastic limit of the material chosen.

The flexible device 20 may comprise more than one set of flexible lateral members 22, with a shared central portion 30.

A gaming device assembly 10 and method are disclosed herein, in which a flexible device 20 is attached to a gaming device 12, so that depressors 24 of the flexible device are positioned adjacent buttons 14 (or other type of touch responsive surfaces) of the gaming device. Flexible lateral members 22 may connect the depressors 24 to a central portion 30 of the flexible device 20. The flexible lateral members 22, the depressors 24 and the central portion 30 may be integrally formed.

The central portion 30 may be secured to an attachment 16. The attachment 16 may be attached (permanently or releasably) to the gaming device 12.

Multiple flexible devices 20 attached to the gaming device 12. Button depressors 24 of a first flexible device 20 may be positioned laterally outward relative to button depressors 24 of a second flexible device 20.

A method of using a gaming device 12 is also disclosed herein. In one example, the method can include attaching an attachment 16 to the gaming device 12 or installing the gaming device in the attachment, and attaching a flexible device 20 to the attachment 16, so that depressors 24 of the flexible device are positioned operatively proximate respective buttons 14 of the gaming device. The flexible device 20 may be attached to the attachment 16 after the attachment 16 is attached to the gaming device 12 or the gaming device is installed in the attachment. In other examples, the flexible attachment 20 may be integrally formed with the attachment 16, or the flexible device may be attached to the attachment before the attachment 16 is attached to the gaming device 12 or the gaming device is installed in the attachment.

Referring specifically now to FIGS. 1-4, a first example of the gaming device assembly 10 is representatively illustrated. The attachment 16 is attached to the outer housing 28 of the gaming device 12. In this example, the outer housing 28 is received in the attachment 16.

The flexible device 20 is then attached to the attachment 16, for example, using fasteners 26. The fasteners 26 secure the central portion 30 of the flexible device 20 to the attachment 16, so that the button depressors 24 are in position to actuate the buttons 14 of the gaming device 12 during game play. The buttons 14 are on opposite sides of the outer housing 28 on a rear side of the gaming device 12. The button depressors 24 overlie and extend rearward from the buttons 14.

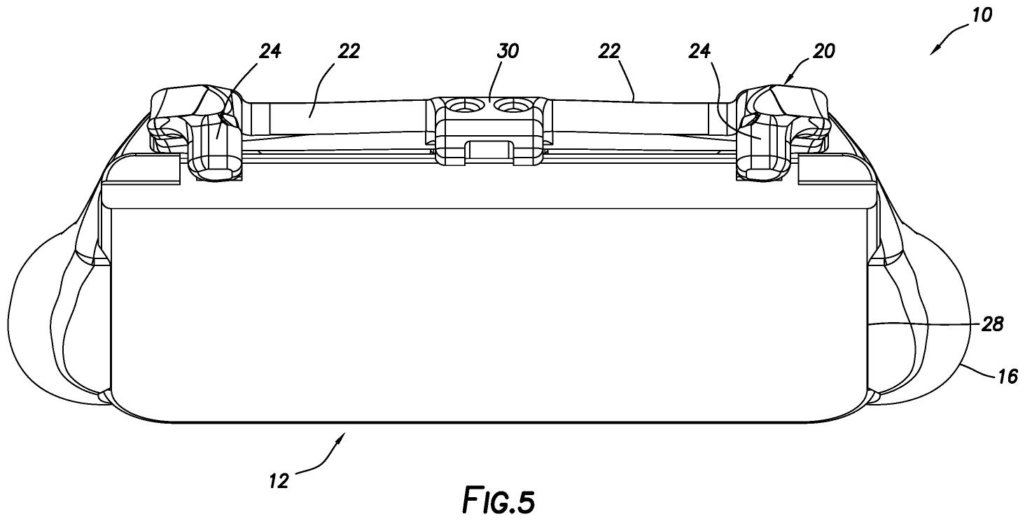

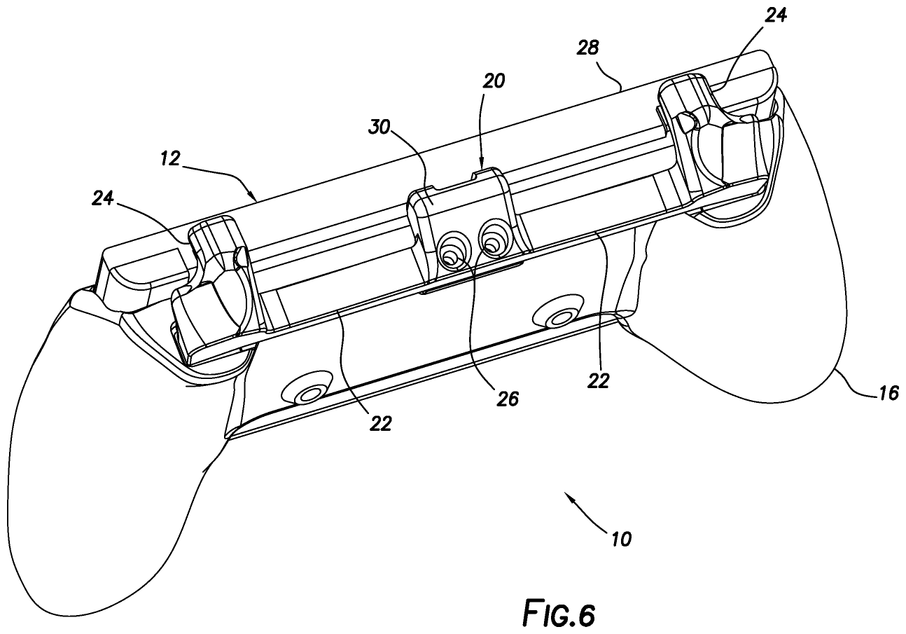

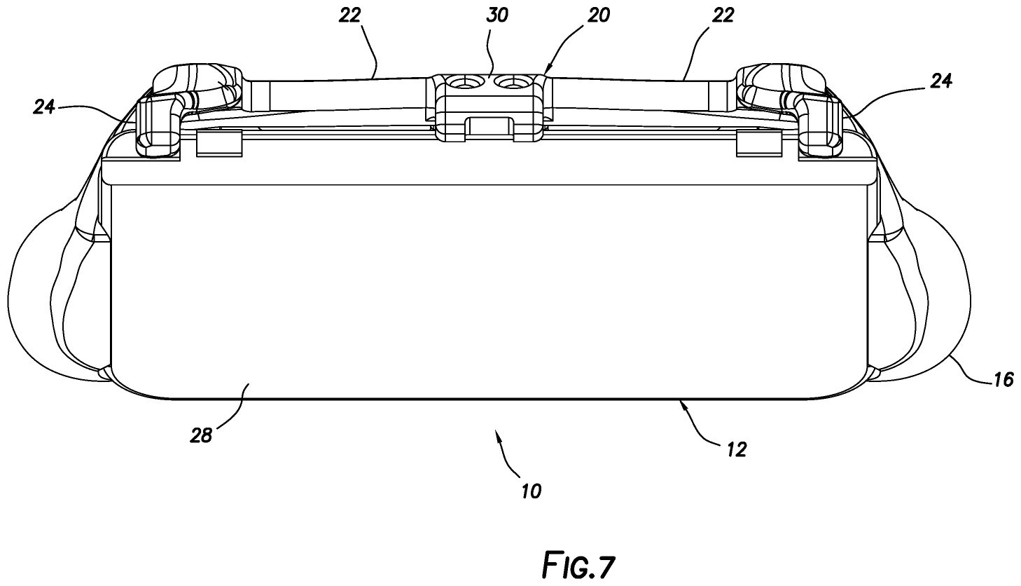

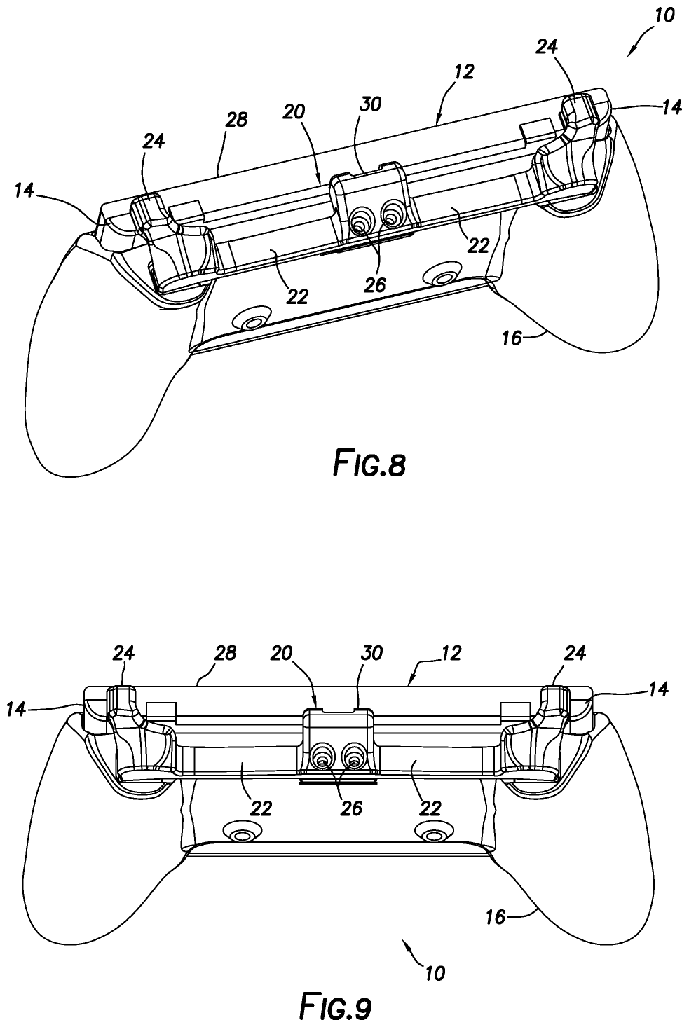

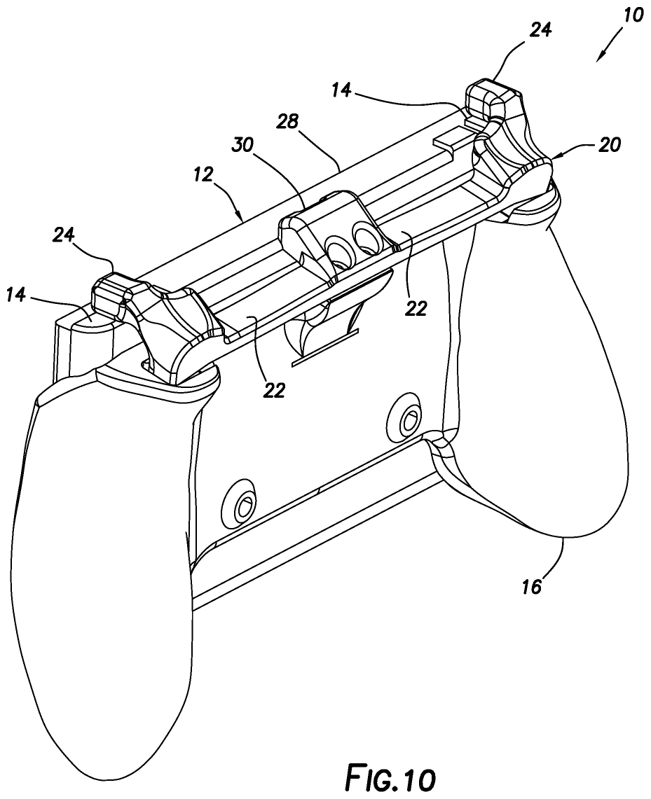

Referring additionally now to FIGS. 5-10, a second example of the gaming device assembly 10 is representatively illustrated. Elements of the FIGS. 5-10 example that are similar to, or perform basically a similar function as, elements of the FIGS. 1-4 example are indicated in FIGS. 5-10 using the same reference numerals.

As depicted in FIGS. 5-10, the buttons 14 (or other type of touch responsive surfaces) of the gaming device 12 are positioned on a top side of the outer housing 28. The attachment 16 is attached to the gaming device 12, with the gaming device being received in the attachment. The flexible device 20 is then attached to the attachment 16 (e.g., using fasteners 26 to secure the central portion 30 to the attachment), so that the depressors 24 overlie and extend rearward from the respective buttons 14.

Referring additionally now to FIGS. 11-13, another example of the gaming device assembly 10 is representatively illustrated. This example is similar to the FIGS. 5-10 example, but in the FIGS. 11-13 example the gaming device 12 includes multiple buttons 14 on each lateral side of the outer housing 28.

Multiple flexible devices 20 are attached to the attachment 16 after the gaming device 12 is installed in the attachment. Each flexible device 20 includes a button depressor 24 at each outer end of two laterally extending flexible members 22.

In this example, the depressors 24 act to rearwardly offset a user's fingers from the buttons 14, with one set of button depressors being positioned more rearward than the other set. In addition, the more rearward set of depressors 24 are positioned closer to each other as compared to the more forward set of button depressors (e.g., to correspond with a reduced distance between the user's middle fingertips as compared to the distance between the user's index fingertips in use).

Referring additionally now to FIGS. 14 & 15, another example of the gaming device assembly 10 is representatively illustrated. In this example, the attachment 16 and the flexible device 20 are integrally formed, or the attachment and flexible device can otherwise be assembled together, prior to attaching the attachment to the gaming device 12.

The attachment 16 is clamped to the outer housing 28 of the gaming device 12, so that the depressors 24 overlie and extend rearward from the buttons 14 (or other type of touch responsive surfaces). The depressors 24 effectively “relocate” the buttons 14 downward and rearward, so that the user can more conveniently actuate the buttons.

It may now be fully appreciated that the above disclosure provides significant improvements to the art of designing, constructing and utilizing handheld gaming devices. A gaming device assembly 10 described above can include an attachment 16 configured to attach to a gaming device 12 having one or more buttons 14 (or other type of touch responsive surfaces), and at least one flexible device 20 securable to the attachment. The flexible device 20 includes one or more depressors 24 configured to be positioned adjacent the touch responsive surfaces when the attachment 16 is attached to the gaming device 12. A method of using a gaming device described above can include attaching an attachment 16 to the gaming device 12, and attaching a flexible device 20 to the attachment, so that depressors 24 of the flexible device are positioned operatively proximate respective touch responsive surfaces 14 of the gaming device.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A gaming device assembly, comprising:
an attachment configured to attach to a gaming device having one or more touch responsive surfaces; and
at least one flexible device securable to the attachment, the flexible device including one or more depressors configured to be positioned adjacent the touch responsive surfaces when the attachment is attached to the gaming device.

2. The gaming device assembly of claim 1, in which flexible lateral members connect the depressors to a central portion of the flexible device.

3. The gaming device assembly of claim 2, in which the flexible lateral members, the depressors and the central portion are integrally formed.

4. The gaming device assembly of claim 2, in which the central portion is secured to the attachment.

5. The gaming device assembly of claim 1, in which the attachment is configured for releasable attachment to the gaming device.

6. The gaming device assembly of claim 1, in which the at least one flexible device comprises multiple flexible devices.

7. The gaming device assembly of claim 6, in which the depressors of a first one of the flexible devices are positioned laterally outward relative to depressors of a second one of the flexible devices.

8. The gaming device assembly of claim 1, in which the depressors are configured to extend rearward from the touch responsive surfaces when the attachment is attached to the gaming device.

9. A method of using a gaming device, the method comprising:
attaching an attachment to the gaming device; and
attaching a flexible device to the attachment, so that depressors of the flexible device are positioned operatively proximate respective touch responsive surfaces of the gaming device.

10. The method of claim 9, in which the flexible device is attached to the attachment after the attachment is attached to the gaming device.

11. The method of claim 9, in which the attaching the attachment to the gaming device comprises receiving the gaming device in the attachment.

12. The method of claim 9, in which the attaching the attachment to the gaming device comprises clamping the attachment to the gaming device.

13. The method of claim 9, in which the flexible device comprises a central portion and flexible lateral members extending between the central portion and the respective depressors.

14. The method of claim 13, in which the attaching the flexible device to the attachment comprises integrally forming the flexible device with the attachment.

15. The method of claim 13, further comprising integrally forming the central portion, the flexible lateral members and the depressors.

16. A gaming device assembly, comprising:
a gaming device having one or more touch responsive surfaces configured to be depressed during game play;
an attachment attached to the gaming device; and
at least one flexible device secured to the attachment, the flexible device including one or more depressors positioned adjacent the touch responsive surfaces.

17. The gaming device assembly of claim 16, in which flexible lateral members connect the depressors to a central portion of the flexible device.

18. The gaming device assembly of claim 17, in which the flexible lateral members, the depressors and the central portion are integrally formed.

19. The gaming device assembly of claim 16, in which the at least one flexible device comprises multiple flexible devices, and in which the depressors of a first one of the flexible devices are positioned laterally outward relative to depressors of a second one of the flexible devices.

20. The gaming device assembly of claim 16, in which the depressors extend rearward from the touch responsive surfaces.
